(19) United States
(12) Patent Application Publication
(10) Pub. No.: US 2013/0151014 A1
(43) Pub. Date: Jun. 13, 2013

(54) HEATING, VENTILATION AND AIR CONDITIONING SYSTEM USER INTERFACE HAVING MEMORY UPGRADE FEATURE AND METHOD OF OPERATION THEREOF

(71) Applicants: Steven C. Lazar, McKinney, TX (US); Stephen J. Vendt, Little Elm, TX (US); Daniel Castillo, Plano, TX (US)

(72) Inventors: Steven C. Lazar, McKinney, TX (US); Stephen J. Vendt, Little Elm, TX (US); Daniel Castillo, Plano, TX (US)

(21) Appl. No.: 13/431,769

(22) Filed: Mar. 27, 2012

Related U.S. Application Data
(60) Provisional application No. 61/569,859, filed on Dec. 13, 2011.

(51) Int. Cl. G05D 23/00

(52) U.S. Cl. 700/276

(57) ABSTRACT

A user interface for use with an HVAC system, a method of providing service reminders on a single screen of a user interface of an HVAC system and an HVAC system incorporating the user interface or the method. In one embodiment, the user interface includes: (1) a display configured to provide information to a user, (2) a touchpad configured to accept input from the user, (3) a processor and memory coupled to the display and the touchpad and configured to drive the display and (4) at least one socket coupled to the processor and configured to receive a media card.

### CROSS-REFERENCE TO RELATED APPLICATION

This application claims the benefit of U.S. Provisional Application Ser. No. 61/569,859, filed by Bias, et al., on Dec. 13, 2011, entitled “Heating, Ventilation and Air Conditioning System User Interface Having One or More of One-Touch Away Feature, Adjustable Fonts, Proportional Animation Graphics, Service Reminders on a Single Screen, Separate Programming and Manual Mode Screens, Integrated Screen/Housing Skin, Low-Profile Housing, Secure Functional Upgrade Feature and Remote Platform Access Application Associated Therewith,” commonly assigned with this application and incorporated herein by reference.

### TECHNICAL FIELD

This application is directed, in general, to a heating, ventilation and air conditioning (HVAC) systems and, more specifically, to an HVAC system having a user interface, such as a thermostat.

### BACKGROUND

Users interact with HVAC systems through user interfaces. The most common user interface employed today is the thermostat. The most basic thermostats feature one or more dials, switches or levers and allow users to set temperatures. More elaborate thermostats feature a liquid crystal display (LCD) screen, perhaps even of the touchscreen variety, and allow users to program their HVAC systems for automatic temperature settings, configure and maintain their HVAC systems and records of historical operation data, allowing the users to gauge the performance and efficiency of their HVAC systems.

Thermostats necessarily include both temperature sensors and control circuitry within their housings. Some user interfaces do not qualify as thermostats, because while they communicate with temperature sensors and control circuitry, they do not include both within their housings.

### SUMMARY

One aspect provides a user interface. In one embodiment, the user interface includes: (1) a display configured to provide information to a user, (2) a touchpad configured to accept input from the user, (3) a processor and memory coupled to the display and the touchpad and configured to drive the display and (4) at least one socket coupled to the processor and configured to receive a media card.

Another aspect provides a method of upgrading memory of a user interface of an HVAC system. In one embodiment, the method includes: (1) storing a version of firmware for the user interface in a media card and (2) providing a socket in the user interface configured to receive the media card.

Yet another aspect provides an HVAC system. In one embodiment, the HVAC system includes: (1) a heat pump or a compressor having at least one stage, (2) at least one condenser coil, (3) an expansion valve, (4) at least one evaporator coil, (5) a loop of pipe interconnecting the heat pump or compressor, the at least one condenser coil, the expansion valve and the at least one evaporator coil and containing a refrigerant, (6) at least one fan configured to cause outdoor air and indoor air to blow over the at least one condenser coil and the least one evaporator coil and (7) a user interface, including: (7a) a display configured to provide information to a user, (7b) a touchpad configured to accept input from the user, (7c) a processor and memory coupled to the display and the touchpad and configured to drive the display and (7d) at least one socket coupled to the processor and configured to receive a media card.

### BRIEF DESCRIPTION

Reference is now made to the following descriptions taken in conjunction with the accompanying drawings, in which:

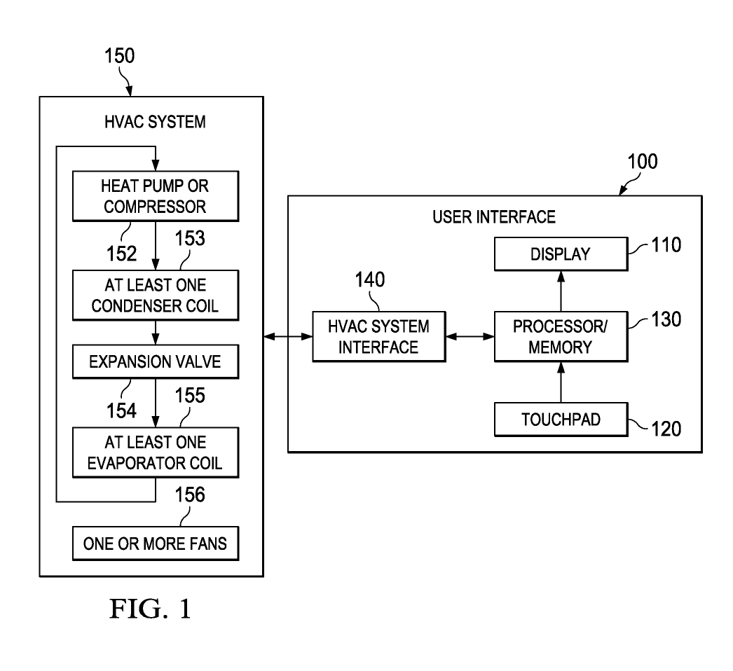

FIG. 1 is a block diagram of one embodiment of a user interface;

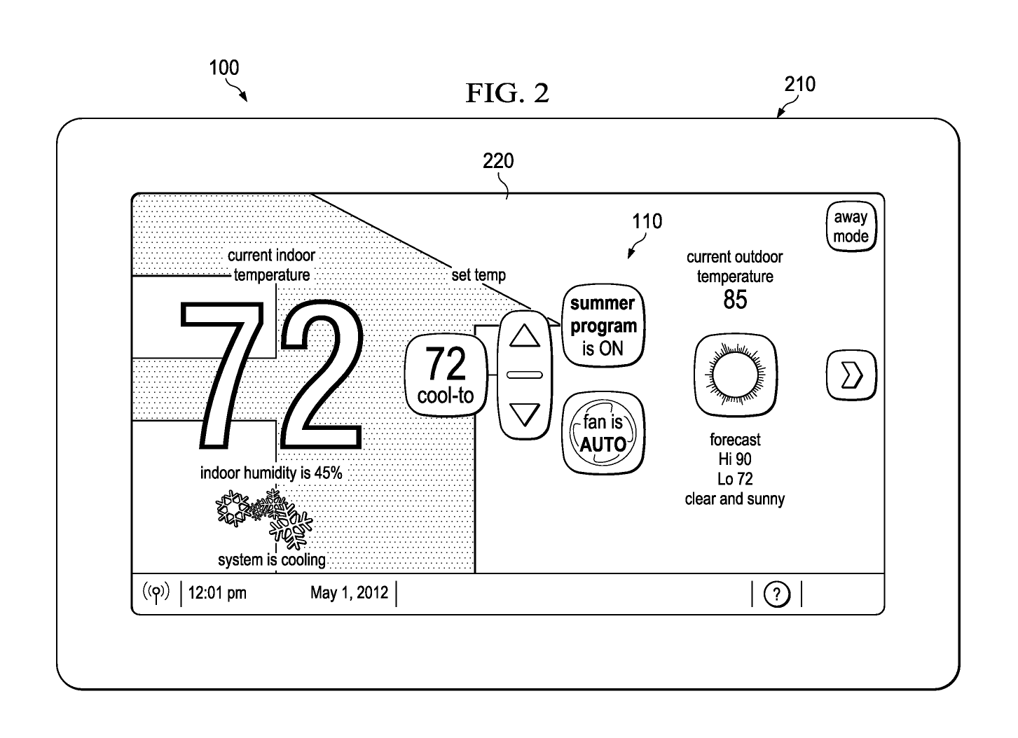

FIG. 2 is a front-side elevational view of one embodiment of a user interface;

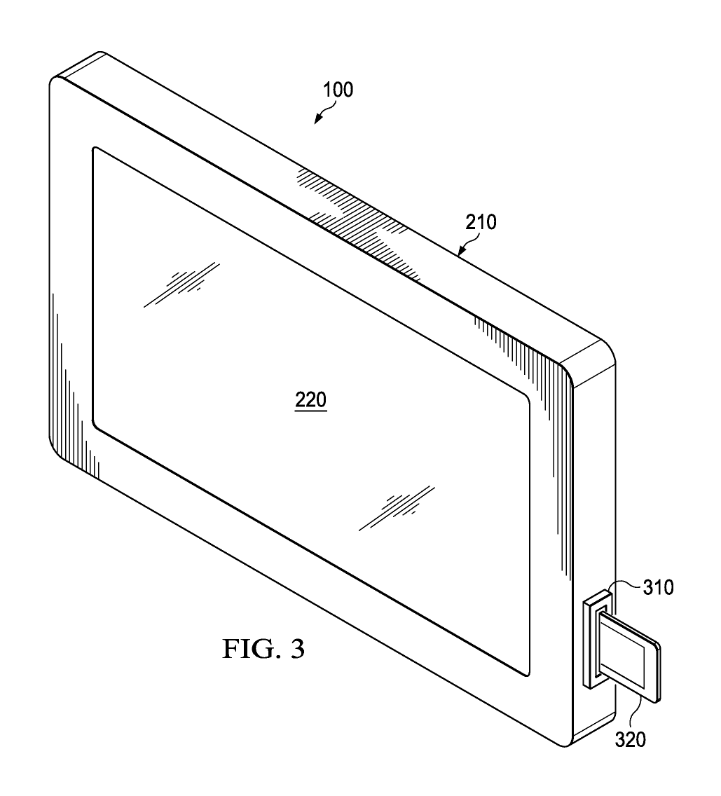

FIG. 3 is a representation of one embodiment of a screen of the user interface of FIG. 2 having one embodiment of a memory upgrade feature;

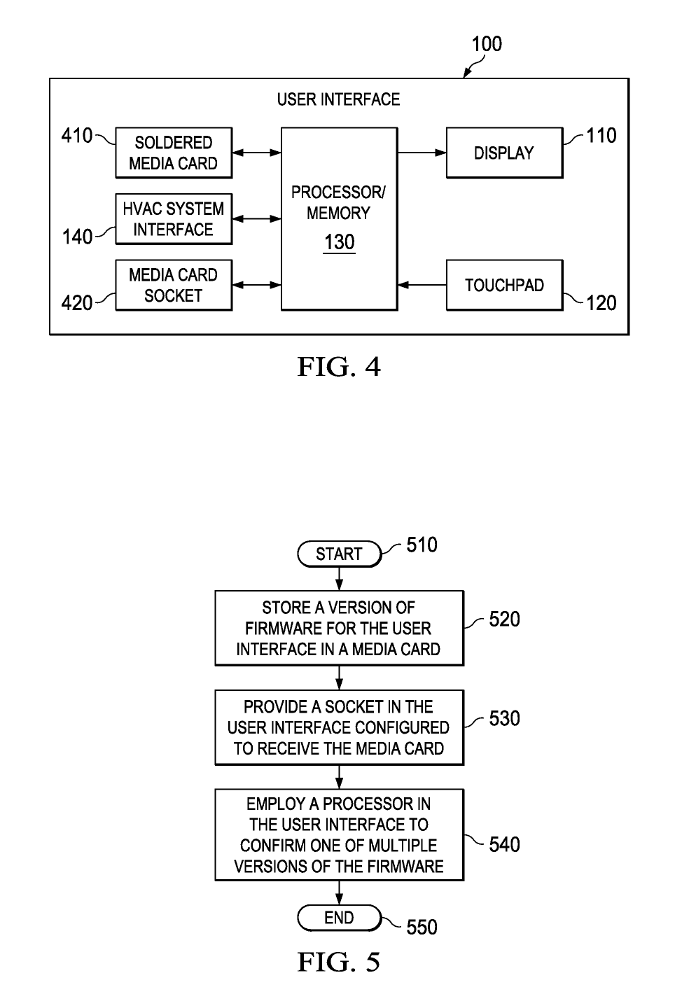

FIG. 4 is block diagram of the user interface embodiment of FIG. 1 that includes one embodiment of a circuit configured to provide a memory upgrade feature to a user interface of an HVAC system; and

FIG. 5 is a flow diagram of one embodiment of a method of upgrading the memory of a user interface of an HVAC system.

### DETAILED DESCRIPTION

FIG. 1 is a block diagram of one embodiment of a user interface 100. The interface has a display 110 and a touchpad 120. The display 110 is configured to provide information to a user, and the touchpad 120 is configured to accept input from a user. A processor and memory 130 are coupled to the display 110 and the touchpad 120 to drive the display 110 and process the input from the touchpad 120. More accurately, software or firmware is loaded into and stored in the memory and, when executed in the processor, configures the processor to drive the display 110 and process the input from the touchpad 120. An HVAC system interface 140 is coupled to the processor and memory 130 and is configured to provide communication between the processor and memory 130 and the remainder of an HVAC system 150. In various embodiments, the HVAC system 150 includes one or more loops of pipe (one being shown and referenced as 151) containing a refrigerant. Each loop transports the refrigerant among a heat pump or a compressor 152 having at least one stage, at least one condenser coil 153, an expansion valve 154 and at least one evaporator coil 155. One or more fans (“blowers”) 156 cause outdoor air and indoor air to blow over the at least one condenser coil 153 and the at least one evaporator coil 155 to transfer heat to or from them. Those skilled in the pertinent art are familiar with conventional HVAC systems and generally understand the many embodiments and forms they may take.

FIG. 2 is a front-side elevational view of one embodiment of the user interface of FIG. 1. The user interface 100 has a bezel 210. The display 110 is configured to display at least one screen 220 of information for the benefit of a user (the term also including an installer or any other person interested in gaining information from the user interface 100).

Although unreferenced, the screen 220 shown in FIG. 2 includes a current temperature display portion, a setpoint temperature display portion, buttons to raise or lower the setpoint temperature, a system mode message display portion (i.e., “system is heating”) and a program status message display portion (i.e., “program is on”). The screen 220 also has current date and time display portions and allows the user to display other screens (via a “press for more” message).

FIG. 3 is a representation of one embodiment of a screen of the user interface of FIG. 2 having one embodiment of a memory upgrade feature.

Some conventional user interfaces (e.g., thermostats) have embedded NAND flash, or other memory media, that are soldered directly to their printed circuit boards (PCBs). Others use flash memory that is embedded in their microprocessors. To upgrade the size of the memory in the field (while installed at the customer) would require the memory device to be un-soldered or the user interface to be replace or sent back to the manufacturer to be reworked.

Unlike a conventional user interface, a flash media card, embodied in secure digital (SD), SDHC (SD high capacity), micro-SD media cards, or any other industry-standard case style or form factor (such as are commonly found in the consumer market), can be used to upgrade a user interface for an HVAC systems that is constructed according to the principles of this disclosure.

In one embodiment, the user interface includes at least one socket configured to receive a media card. FIG. 3 accordingly shows one embodiment of a socket 310 containing one embodiment of a media card 320. In the illustrated embodiment, the socket 310 is positioned such that it is accessible from outside of the user interface, allowing a media card to be readily inserted or removed without having to disassemble the user interface. In another embodiment, the socket 310 is mounted on a supporting PCB such that the user interface must be at least partially disassembled, exposing the PCB and socket 310 and allowing the media card to be readily inserted or removed.

In another embodiment, one or more additional sockets are configured to receive another media card or other media cards. In yet another alternative embodiment, one or more additional media cards are soldered directly to the PCB. In still another embodiment, the PCB layout accommodates one or more additional sockets and one or more additional cards. In various embodiments, the media card is a standard or micro flash card. In other embodiments, the media card is another conventional or later-developed type or form factor of media card.

FIG. 4 is block diagram of the user interface embodiment of FIG. 1 that includes one embodiment of a circuit configured to provide a memory upgrade feature to a user interface of an HVAC system. The embodiment of FIG. 4 shows both a soldered media card 410 and a media card socket 420 coupled to the processor and memory 130.

With this feature, new firmware can be implemented in the field without the need for special connection “dongles” or special tools because all the dealer needs to do is remove the memory card and install a new memory card with the new firmware. If the SD card fails, the dealer could purchase the readily available SD card and program the card and replace the damaged card without returning the user interface back to the manufacturer. Some SD cards have their own built in memory checkers and controllers so they can “write around” bad sections of memory. Traditional memory devices have to use the microprocessor and special algorithms to accomplish this feature.

In one embodiment, the memory card allows different versions of the firmware to be saved. In a more specific embodiment, several different versions of the firmware may be saved, namely the factory-original version firmware, current version firmware and just-upgraded version firmware (perhaps only until it is confirmed to be a valid copy and eligible for use in lieu of the current version firmware), which provides the ability to revert back to the earlier, “current” version firware or the factory version firmware without hampering the operation of the user interface. If a user were to put a traditional memory device to this use, much larger memory sizes and memory mapping would be required, making the user interface more expensive.

This feature allows the firmware to be replaced easily. During the development phase, it is much easier for trying out new versions of firmware. In the field, the dealer can remove the SD card without any special tools. This feature eliminates the need for the unit to be returned to the manufacturer to get new firmware upgrades.

This feature is expected to have a lower manufacturing cost. SD cards can be programmed in multiple banks. The embedded memories are more expensive if they are programmed off the production line or add to the production time if programmed after they are installed in the device.

This feature provides a future path for upgrading the size of the memory. Increasing the size of the embedded memory devices may require the footprint to change which could require a new board design and increase time to market.

This feature is expected to provide a lower cost than embedded solutions. Because of the consumer demand for SD type memory devices, the high volumes and competitive pressures drive the cost of the SD card lower. This feature can also minimizes obsolescence of memory devices. The SD cards are governed by a standards body, which controls the form, fit and function. There are some many uses for the SD cards for which the memory industry will provide backwards compatible devices.

FIG. 5 is a flow diagram of one embodiment of a method of upgrading the memory of a user interface of an HVAC system. The method begins in a start step 510. In a step 520, a version of firmware for the user interface is stored in a media card. In a step 530, a socket is provided in the user interface configured to receive the media card. In one embodiment, multiple versions of firmware for the user interface are stored in the media card. In a related embodiment, at least one of the versions is transmitted to the media card for storage therein over a network. In various, more specific embodiments, the network is the Internet, a wireless communication link, or both. In a step 540, a processor in the user interface to confirm one of the multiple versions. In a more specific embodiment, the one of the multiple versions is employed as the firmware in lieu of an earlier version after confirmation is complete. The method ends in an end step 550.

Those skilled in the art to which this application relates will appreciate that other and further additions, deletions, substitutions and modifications may be made to the described embodiments.

1. A user interface for use with an HVAC system, comprising:
a display configured to provide information to a user;
a processor and memory coupled to said display and configured to drive said display; and
at least one socket coupled to said processor and configured to receive a media card.

2. The user interface as recited in claim 1 further comprising an additional media card soldered to a printed circuit board within said user interface.

3. The user interface as recited in claim 1 wherein said media card is selected from the group consisting of:
a standard flash card, and
a micro flash card.

4. The user interface as recited in claim 1 wherein said media card is a secure digital media card selected from the group consisting of:
a standard secure digital media card,
a high-capacity secure digital media card, and
a micro-secure digital media card.

5. The user interface as recited in claim 1 wherein said media card contains factory-original version firmware for said user interface.

6. The user interface as recited in claim 1 wherein said media card contains multiple versions of firmware for said user interface, at least one of said versions being transmitted to said media card for storage therein over a network.

7. The user interface as recited in claim 6 wherein said processor is configured to confirm one of said multiple versions.

8. A method of upgrading memory of a user interface of an HVAC system, comprising:
storing a version of firmware for said user interface in a media card; and
providing a socket in said user interface configured to receive said media card.

9. The method as recited in claim 8 wherein said user interface has an additional media card soldered to a printed circuit board within said user interface.

10. The method as recited in claim 8 wherein said media card is selected from the group consisting of:
a standard flash card, and
a micro flash card.

11. The method as recited in claim 8 wherein said media card is a secure digital media card selected from the group consisting of:
a standard secure digital media card,
a high-capacity secure digital media card, and
a micro-secure digital media card.

12. The method as recited in claim 8 wherein said version is a factory-original version.

13. The method as recited in claim 8 wherein said storing comprises:
storing multiple versions of said firmware for said user interface in said media card; and
transmitting at least one of said versions to said media card for storage therein over a network.

14. The method as recited in claim 13 further comprising employing a processor in said user interface to confirm one of said multiple versions.

15. An HVAC system, comprising:
a heat pump or a compressor having at least one stage;
at least one condenser coil;
an expansion valve;
at least one evaporator coil;
a loop of pipe interconnecting said heat pump or compressor, said at least one condenser coil, said expansion valve and said at least one evaporator coil and containing a refrigerant;
at least one fan configured to cause outdoor air and indoor air to blow over said at least one condenser coil and said least one evaporator coil; and
a user interface, including:
a display configured to provide information to a user,
a touchpad configured to accept input from said user,
a processor and memory coupled to said display and said touchpad and configured to drive said display, and
at least one socket coupled to said processor and configured to receive a media card.

16. The HVAC system as recited in claim 15 further comprising an additional media card soldered to a printed circuit board within said user interface.

17. The HVAC system as recited in claim 15 wherein said media card is selected from the group consisting of:
a standard flash card, and
a micro flash card.

18. The HVAC system as recited in claim 15 wherein said media card is a secure digital media card selected from the group consisting of:
a standard secure digital media card,
a high-capacity secure digital media card, and
a micro-secure digital media card.

19. The HVAC system as recited in claim 15 wherein said media card contains factory-original version firmware for said user interface.

20. The HVAC system as recited in claim 15 wherein said media card contains multiple versions of firmware for said user interface, at least one of said versions being transmitted to said media card for storage therein over a network.

21. The HVAC system as recited in claim 20 wherein said processor is configured to confirm one of said multiple versions.
